(19) United States
(12) Patent Application Publication
(10) Pub. No.: US 2009/0299903 A1
(43) Pub. Date: Dec. 3, 2009

(54) Non-Cash Cash-on-Delivery Method and System

(75) Inventors: TZU-CHIEN HUNG, Kaohsiung City (TW); YUEH-O WU, Taipei City (TW); CHYUAN-LU SHEU, Taipei City (TW)

Correspondence Address: WPAT, PC;INTELLECTUAL PROPERTY ATTORNEYS, 7225 BEVERLY ST., ANNANDALE, VA, 22003, US

(73) Assignee: Taiwan Pelican Express Co., Ltd., Taipei City (TW)

(21) Appl. No.: 12/329,160

(22) Filed: Dec. 5, 2008

Related U.S. Application Data
(60) Provisional application No. 61/012,188, filed on Dec. 7, 2007.

(51) Int. Cl. G06Q 20/00; G06K 7/10

(52) U.S. Cl. 705/44; 235/462.11

(57) ABSTRACT

The present invention provides a method and system for non-cash cash-on-delivery. In the conventional process of the cash-on-delivery in logistics, a wireless communication apparatus is provided to read the information of the identification docket number and a non-cash payment tool, and the information is transported to the logistics server so as to accomplish the mechanism of the collecting-and-paying for another with a financial institution.

### BACKGROUND OF THE INVENTION

1. Field of the Invention

The present invention relates to method and system for cash-on-delivery, particularly to a non-cash cash-on-delivery method and system.

2. Description of the Prior Art

For the conventional mail order or on-line deal, the capital flow and logistics usually are independent operations. In another word, the buyer may pay in advance by transfer or on-line card-swipe. Then the seller delivers the goods to the buyer through the logistics provider. Therefore, it could happen that the seller did not deliver the goods on agreement after the buyer had paid.

Therefore, there is a derived payment method combining the cash payment and cash-on-delivery. When the buyer and the seller agree on the payment for goods, the logistics provider authorized by the seller collects for another when the goods are received, and then the payment is transferred to the seller to accomplish the goal of collecting-and-paying for another. Because the transfer or credit card payment needs to be managed and controlled by the financial information center or credit card payment center, it is a kind of real-time operation model. If the logistics provider wants to achieve the purpose of the non-cash cash-on-delivery, it is necessary to have the identification of the credit card machine or financial institution. There is the risk of information leak as well, and there is the difficulty to practice.

### SUMMARY OF THE INVENTION

Therefore, in accordance with the previous summary, objects, features and advantages of the present disclosure will become apparent to one skilled in the art from the subsequent description and the appended claims taken in conjunction with the accompanying drawings.

An object of the present invention is to provide a non-cash cash-on-delivery method, as shown in FIG. 3. At first, referring to Step 310, the first party and the second party agree on a deal including an agreement for a target item and non-cash cash-on-delivery information. The non-cash cash-on-delivery information includes a payment amount. Next, referring to Step 320, the first party provides the non-cash cash-on-delivery information for the third party, and the first party has an identification account number from the third party. Accordingly, referring to Step 330, the third party records the non-cash cash-on-delivery information and identification docket number in a server. The non-cash cash-on-delivery information corresponds to the identification docket number, and the server is connected to a wireless network and financial network. Next, referring to Step 340, the first party indicates the identification docket number on the target item by the first carrier, and delivers the target item to the third party, and also the third party delivers the target item to the second party. Next, referring to Step 350 and 360, the identification docket number is entered to a wireless transportation apparatus by the first carrier. The wireless transportation apparatus is connected to the wireless network. The second party provides the paying medium information for the wireless transportation apparatus by a non-cash paying medium. The wireless transportation apparatus includes the first interface, and reads the paying medium information by the non-cash paying medium through the first interface. Next, referring to Step 370, the wireless transportation apparatus transports the paying medium information and identification docket number to the server by the wireless network through a wireless communication protocol. Next, referring to Step 380, the server verifies the identification docket number and the payment amount to generate a identifying result, and provides the paying medium information and payment amount of the deal for a financial institution through a financial network according to the identifying result. Next, referring to Step 390, the financial institution authorizes the server through the financial network according to the paying medium information and payment amount of the deal, transfers the first transfer payment amount to the third party according to the authorization. Next, referring to Step 400, the server converts the authorization to the authorization information, and provides the authorization information for the wireless transportation apparatus by the wireless network through the wireless communication protocol. Next, referring to Step 410, the wireless transportation apparatus prints the authorization information for the second party. At last, referring to Step 420, the third party delivers the target item to the second party, and transfers the second transfer payment amount to the first party according to the authorization and identification docket number.

An object of the present invention is to provide a non-cash cash-on-delivery system, comprising a logistics sub-system and at least a wireless transportation apparatus. The logistics sub-system comprises at least a computer system with a logistics managing software so that the logistics sub-system comprises the following apparatuses: the first apparatus for receiving non-cash cash-on-delivery information, wherein the first party and the second party agree on a deal comprising a target item and the non-cash cash-on-delivery information, wherein the non-cash cash-on-delivery information comprises a payment amount; the second apparatus for generating a identifying docket number according to the non-cash cash-on-delivery information, wherein the non-cash cash-on-delivery information corresponds to the identifying docket number; the third apparatus for recording the payment amount of a deal and the identifying docket number; the fourth apparatus, connected to a wireless networking and a financial network; the fifth apparatus receiving a paying medium information and the identifying docket number through a wireless communication protocol by the wireless network; the sixth apparatus for identifying the identifying docket number and the payment amount for the deal to generate a identifying result; the seventh apparatus for providing paying medium information and the payment amount of the deal through the financial network by the identifying result; the eighth apparatus for receiving an authorization, wherein the financial institution provides the authorization through the financial network according to the paying medium information and the payment amount of the deal; and the ninth apparatus for converting the authorization to an authorization information and providing the authorization information through the wireless communication protocol by the wireless network.

Besides, the wireless transportation apparatus, connected to the wireless network, comprises: the tenth apparatus for reading the identifying docket number by the first carrier; the eleventh apparatus for reading a paying medium information of a non-cash paying medium; the twelfth apparatus for transporting the paying medium information and identifying docket number to the logistics sub-system through the wireless communication protocol by the wireless network; the thirteenth apparatus for receiving the authorization information through the wireless communication protocol by the wireless network; and the fourteenth apparatus for printing the authorization information in the second carrier.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 is the functional block diagram of the non-cash collecting-for-another method according to the present invention;

FIG. 2 is the timing flowchart diagram of an embodiment of the non-cash collecting-for-another method according to the present invention; and

FIG. 3 is the flowchart diagram of an embodiment of the non-cash collecting-for-another method according to the present invention.

### DETAILED DESCRIPTION OF THE PREFERRED EMBODIMENTS

The present disclosure can be described by the embodiments given below. It is understood, however, that the embodiments below are not necessarily limitations to the present disclosure, but are used to a typical implementation of the invention.

Having summarized various aspects of the present invention, reference will now be made in detail to the description of the invention as illustrated in the drawings. While the invention will be described in connection with these drawings, there is no intent to limit it to the embodiment or embodiments disclosed therein. On the contrary the intent is to cover all alternatives, modifications and equivalents included within the spirit and scope of the invention as defined by the appended claims.

It is noted that the drawings presents herein have been provided to illustrate certain features and aspects of embodiments of the invention. It will be appreciated from the description provided herein that a variety of alternative embodiments and implementations may be realized, consistent with the scope and spirit of the present invention.

It is also noted that the drawings presents herein are not consistent with the same scale. Some scales of some components are not proportional to the scales of other components in order to provide comprehensive descriptions and emphasizes to this present invention.

The present invention provides the non-cash procedure of collecting-for-another, including sending and delivery procedure.

1. Sending Procedure

(1) A set of identifying docket number (logistics docket number, including in one-dimension bar code, two-dimension bar code, or digital identifying number, but not limited) is provided to be posted (indicated) on the delivery package or docket when the customer sends goods. The identifying docket number is generated by a coding logic to judge if the key-in is correct.

(2) Sending goods for the customer can be charged for the service. The charging fee is received and then transferred to the customer, and the charging fee is paid for a part of the delivery service, including the delivery fee, the value of the goods, or the payment amount of the sale, but not limited. The payment receiving method includes paying by cash, credit card, financial card (ATM card, advance payment card), or paying medium authorized by bank. But it has to be the accepted payment method on the agreement in advance.

(3) The identifying docket number, service fee receiving method, and service fee information for sending goods is entered the delivery provider's information system by key-in or scanning.

2. Informing the Receiver the Charge Amount when Delivering Goods to the Receiver

(1) The payment is not paid by cash if the receiver receives the goods according to the agreement with the sender.

(2) The credit card machine is adopted to judge the anti-forging feature, check the true-and-false of the card (or the paying medium), and verify the valid period.

(3) It is necessary to key in or scan the logistics docket number by the card swipe machine for identifying the sending and receiving information and payment for service charge and proceeding with managing.

(3.1) No matter if the collecting-for-another of the same logistics docket number is paid by the same paying medium, it can be entered once only. But if the deal is accomplished, it can be operated again after the card-swipe of the whole payment of the deal is completed. The card swipe machine can control the usage frequency of the day by the same paying medium.

(3.2) The card swipe machine verifies the accuracy and repetition of the home-delivery docket number, and the validity of the paying medium, and then the card swipe machine is connected to the financial institution to proceed with authorizing.

(4) After the card swipe machine acquires the authorization code from the financial institution, the identifying docket number and the authorization code are printed on the payment bill. And the receiver signs on the payment bill.

(5) The receiver signs in the signature section of the home-delivery bill to accomplish the payment verification.

3. Delivery for Information

The whole deal information stream is divided to two parts:

(1) the logistics provider sending the information (the delivery situation) of the received goods back to the server of the logistics provider.

(2) exchanging information with the financial unit.

1. Besides the payment paid by cash, the paying medium (credit card, chip card, and financial card) information of the receiver, payment amount, and logistics docket number information are sent back to the financial institution by the card swipe machine.

(1) Besides the server of the financial institution and the server of the logistics provider, another server for classifying information is set up. The financial institution stores the information of the deal in the information-classifying server except the financial information which needs to be kept secret.

(2) The logistics provider is connected on line to the information-classifying server to get the identifying docket number, payment amount, paying date, timing information, and employ the information to compare and integrate with the sender's information to confirm that the payment amount is correct.

2. The financial institution transfers the payment from the receiver (not the sender) to the logistics provider. The logistics provider deducts the necessary charge, and then transfers the rest to the sender, and also provides the complete payment bill of the deal for the sender.

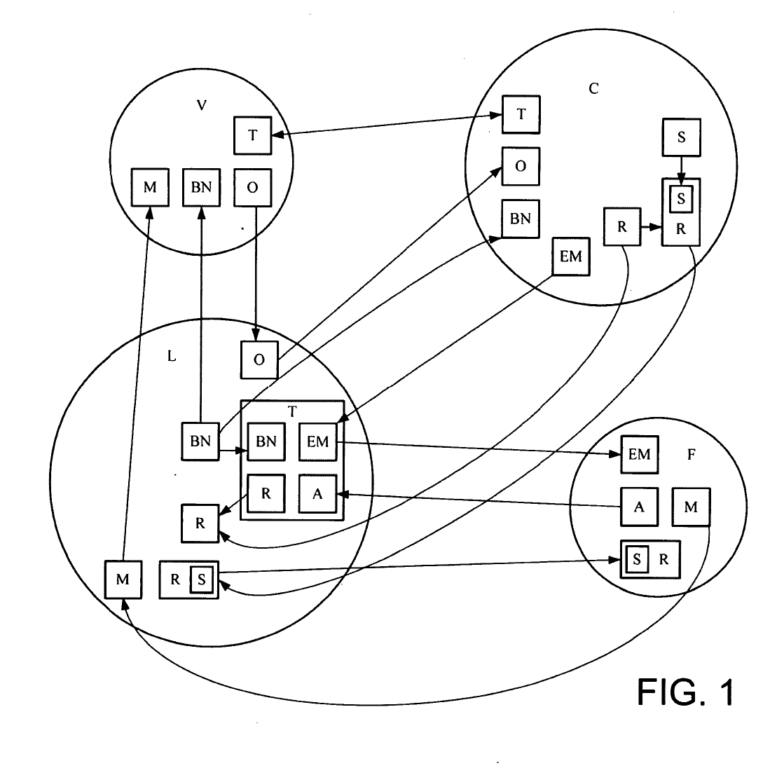

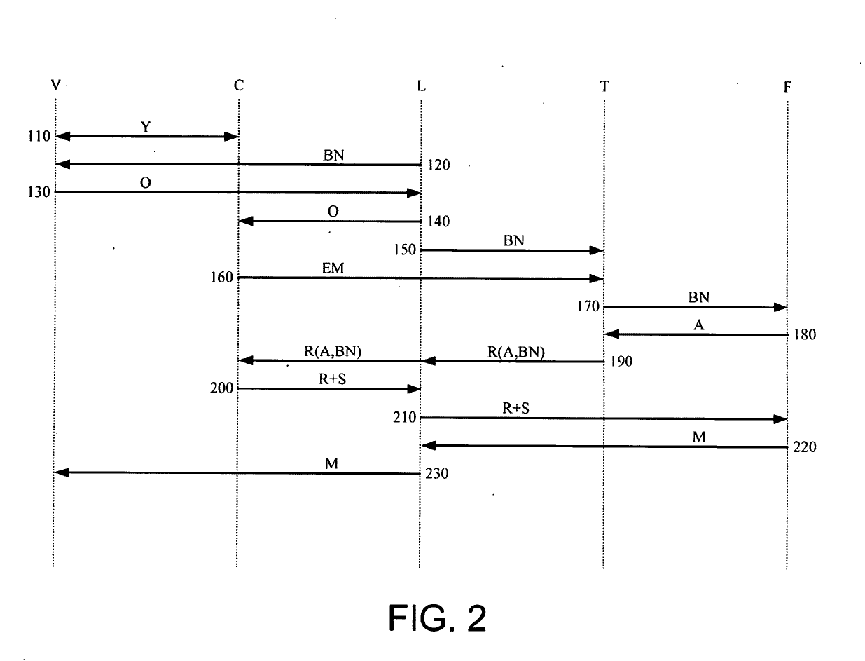

Accordingly, an embodiment of the present invention as shown in FIG. 1 and 2 is the non-cash collecting-for-another method. At first, referring to Step 110, the first party V and the second party C agreed on a deal or accomplish a deal Y. The deal is a long-distance deal. The first party V and the second party C cannot complete the action of paying face to face so as to agree on a kind of method for paying via the third party L to deliver the target item O and to collect and pay the relevant deal charge M.

Next, referring to Step 120 and 130, the third party L provides the first party V a identifying docket number BN, and the first party L sends the target item O to the third party L. In an embodiment of the present invention, the third party L provides the identifying docket number BN for the first party V at first, and the first party V sends the target item O with the identifying docket number BN to the third party L. For example, a seller (the first party V) gets the identifying docket number BN from the logistics provider (the first party V) via the internet or the other contact method, and then the seller indicates the identifying docket number BN on the target item O. The identifying docket number BN may be indicated in a carrier, such as a sticker, and then the seller pastes the sticker on the target item O, or the seller writes it on the target item O. One skilled in the art can understand there are other methods to indicate the identifying docket number BN on the target item O. The present invention does not indicating method. Besides, the target item O may be a single item or a collection of multiple items, and may comprise the packing item or carrier which packs the target item, not limited in the present invention. In an embodiment of the present invention, the identifying docket number BN may be indicated on the target item O by the third party L. Besides, in an embodiment of the present invention, it is not necessary that the identifying docket number BN is combined with the target item O in any form. In addition, the identifying docket number BN can exist or be recorded in figure or word format for identifying, such as the text, one-dimension bar code, two-dimension bar code, electromagnetic record, or other figure which can be identified, not limited in the present invention. For example, the identifying docket number BN can be the electromagnetic record adopted for the electromagnetic sensor storage medium, such as the electromagnetic sensor card or chip.

Next, referring to Step 140, the third party L delivers the target item O to the second party C. In an embodiment of the present invention, when the third party L delivers the target item O to the second party C, the second party C receives the identifying docket number BN. For example, the second party C receives the target item with the indicated identifying docket number BN.

Next, referring to Step 150, the third party L receives the identifying docket number BN by a wireless transportation apparatus T. In an embodiment of the present invention, the identifying docket number BN can be manually entered to the wireless transportation apparatus T by the third party L, or the wireless transportation apparatus T is connected to an electronic key-in apparatus and the wireless transportation apparatus T receives and identifies the identifying docket number BN via wired or wireless transportation by photo shooting, scanning, electromagnetic sensing, not limited in the present invention. For example, the electronic key-in apparatus may be the bar code scanner for scanning the one-dimension bar code or two-dimension bar code, card reader for reading the magnetic strip or chip, card reader for sensor card by electromagnetic sensing, scanner capable of identifying text or photo device, and so on. In an embodiment of the present invention, the identifying docket number BN can be acquired by the electronic apparatus of the second party C by the electronic key-in apparatus mentioned above. For example, the electronic key-in apparatus acquires the identifying docket number BN by means of wireless transportation (such as Bluetooth, infrared, WIFI, WIMAX . . . ), wired transportation, photo shooting, scanning. For example, the identifying docket number BN can be transported to the electro apparatus in advance by the third party. A two-dimension bar code indicating the identifying docket number BN is transported to the electronic apparatus and the electronic apparatus displays the two-dimension bar code. The identifying docket number BN is identified by scanning or photo-shooting the two-dimension bar code via the wireless transportation apparatus T.

Next, referring to Step 160, 170, and 180, the second party C delivers a paying medium information EM to the wireless transportation apparatus T by a non-cash paying medium. The wireless transportation apparatus T transports the paying medium information EM to a financial institution F through a wireless communication protocol by a wireless network. The wireless transportation apparatus T acquires an authorization A in time from the financial institution F accordingly. In an embodiment of the present invention, the non-cash paying medium can be a financial card, credit card, mobile phone, or any other apparatus which can transports the paying medium information EM to the wireless transportation apparatus T. Therefore, the wireless transportation apparatus T may be the electromagnetic record stored in the magnetic strip, chip, electronic storage medium, or text recorded in a carrier (such as the credit card, financial card) or engraving, or the other information which can transport the paying medium information EM by image, voice, or electronic transportation. For example, the paying medium information EM can be the authorization code acquired from the financial institution F in advance by the second party C. The authorization code can be downloaded to the mobile phone, digital camera, PDA, computer, multi-media player. Therefore, the authorization code can be the displayed image, voice, and can be accepted by the wireless transportation apparatus T transported by wired or wireless transportation. For example, the wireless transportation apparatus T can be the authorization-code image, recorded voice, authorization-code voice performed by audio frequency (such as DTMF) accomplished by photo-shooting or scanning the non-cash paying medium. Or the wireless transportation apparatus T can be the analog or digital electromagnetic record transported by wired or wireless transportation. The present invention does not limit the method that the wireless transportation apparatus T receives the paying medium information EM or the model of the wireless transportation apparatus T. Besides, in an embodiment of the present invention, when the wireless transportation apparatus T sends the paying medium information EM, the identifying docket number BN is transported to the financial institution F. In addition, communication protocol adopted by the wireless transportation apparatus T mentioned above through the communication network can be GSM, GPRS, WAP, Bluetooth, infrared transportation communication protocol, WIFI, WIMAX, and so on.

Next, referring to Step 190, 200, and 210, the wireless transportation apparatus T generates a receipt R according to the authorization A and the identifying docket number BN. The receipt R is provided for the second party C through the third party L. The second party C signs, stamps, or adopts the other action which can record to identify the receipt information S in the receipt R, and then the third party L sends the receipt with the receipt information S to the financial institution F. In an embodiment of the present invention, the receipt R records the identifying docket number BN or the authorization A mentioned above.

Next, referring to Step 220, 230, the financial institution F pays a payables M to the third party L according to the identifying docket number BN, and the third party L pays a payables M for the first party V according to the authorization A and the identifying docket number BN. In an embodiment of the present invention, the method for paying the payables M can be accomplished by electronic transaction. One skilled in the art can understand the other methods for paying, such as paying by check, cash and so on, not limited in the present invention. In an embodiment of the present invention, when the financial institution F pays the payables M to the third party L, financial institution F also provides the corresponding identifying docket number BN of the payables M in the meantime, and when the third party L pays the payables M, the third party L provides the corresponding identifying docket number BN of the payables M for the first party V as well.

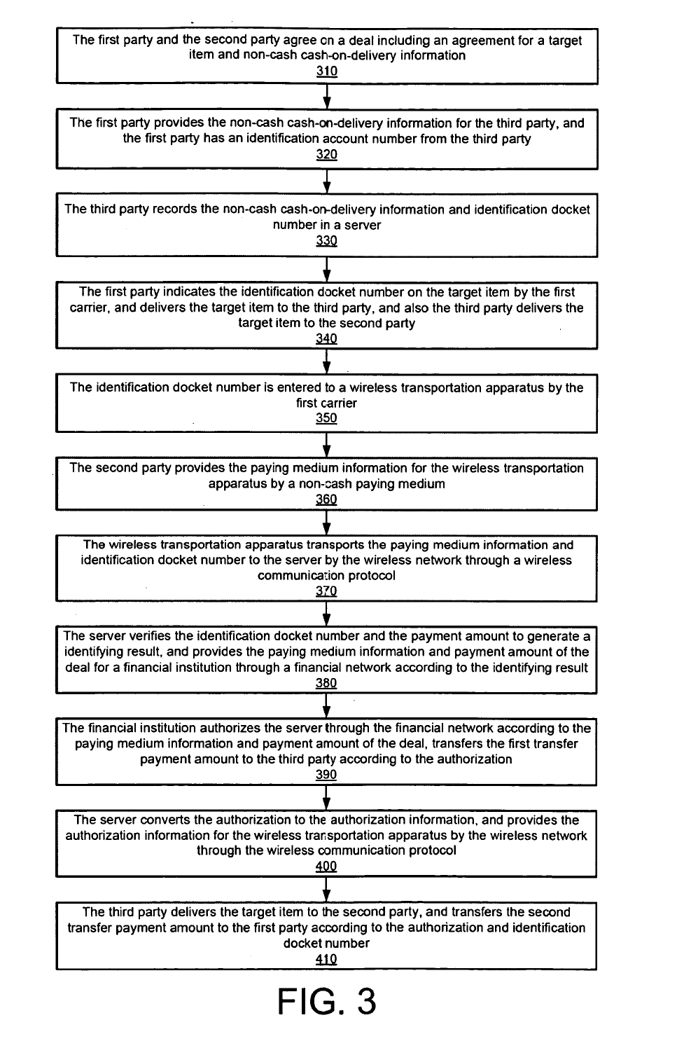

Accordingly, An embodiment of the present invention is a non-cash cash-on-delivery method, as shown in FIG. 3. At first, referring to Step 310, the first party and the second party agree on a deal including an agreement for a target item and non-cash cash-on-delivery information. The non-cash cash-on-delivery information includes a payment amount. Next, referring to Step 320, the first party provides the non-cash cash-on-delivery information for the third party, and the first party has an identification account number from the third party. Accordingly, referring to Step 330, the third party records the non-cash cash-on-delivery information and identification docket number in a server. The non-cash cash-on-delivery information corresponds to the identification docket number, and the server is connected to a wireless network and financial network.

Next, referring to Step 340, the first party indicates the identification docket number on the target item by the first carrier, and delivers the target item to the third party, and also the third party delivers the target item to the second party.

Next, referring to Step 350 and 360, the identification docket number is entered to a wireless transportation apparatus by the first carrier. The wireless transportation apparatus is connected to the wireless network. The second party provides the paying medium information for the wireless transportation apparatus by a non-cash paying medium. The wireless transportation apparatus includes the first interface, and reads the paying medium information by the non-cash paying medium through the first interface. The non-cash paying medium mentioned above may be a credit card, financial card, chip card, electromagnetic sensor card, or any carrier which can record the paying medium information. It also can be the electronic apparatus which comprises the display function or can transport paying medium information in wired or wireless method. For example, the non-cash paying medium mentioned above may be a mobile communication apparatus (such as a cell phone). The mobile communication apparatus displays the multi-media information to provide the paying medium information. The multi-media information can be selected from the combination of the group: image, voice, text. For example, the paying medium information is displayed on the mobile communication apparatus in the format of a one-dimension bar code or two-dimension bar code.

In an embodiment of the present invention, the non-cash paying medium mentioned above is a credit card/financial card, and the paying medium information is the card swipe information. In another word, the wireless communication apparatus comprises the function of the card swipe machine or card reader or read the credit card/financial card for generating the card swipe information.

Next, referring to Step 370, the wireless transportation apparatus transports the paying medium information and identification docket number to the server by the wireless network through a wireless communication protocol. Next, referring to Step 380, the server verifies the identification docket number and the payment amount to generate a identifying result, and provides the paying medium information and payment amount of the deal for a financial institution through a financial network according to the identifying result. Besides, Step 380 comprises the password identifying mechanism. For example, the wireless transportation apparatus can send a password to the server through the wireless communication protocol by the wireless network, and the server provides the password for the financial institution by the financial network. Besides, the financial institution can acquire the information of the first party from the third party by employing the identifying docket number for trust authorization or safety control.

Next, referring to Step 390, the financial institution authorizes the server through the financial network according to the paying medium information and payment amount of the deal, transfers the first transfer payment amount to the third party according to the authorization. In the example for comprising the password identifying mechanism, the financial institution provides authorization after identifying the paying medium information, payment amount of the deal, and password.

Next, referring to Step 400, the server converts the authorization to the authorization information, and provides the authorization information for the wireless transportation apparatus by the wireless network through the wireless communication protocol. Next, referring to Step 410, the wireless transportation apparatus prints the authorization information for the second party. Beside, the wireless transportation apparatus mentioned above can comprise the third interface. The wireless transportation apparatus reads the signature on the second carrier through the third interface to generate the signature information. And the wireless transportation apparatus provides the signature information for the server through the wireless communication protocol by the wireless network.

At last, referring to Step 420, the third party delivers the target item to the second party, and transfers the second transfer payment amount to the first party according to the authorization and identification docket number.

Accordingly, an embodiment of the present invention is a non-cash cash-on-delivery system, comprising a logistics sub-system and at least a wireless transportation apparatus. The logistics sub-system comprises at least a computer system with a logistics managing software so that the logistics sub-system comprises the following apparatuses: the first apparatus for receiving non-cash cash-on-delivery information, wherein the first party and the second party agree on a deal comprising a target item and the non-cash cash-on-delivery information, wherein the non-cash cash-on-delivery information comprises a payment amount; the second apparatus for generating a identifying docket number according to the non-cash cash-on-delivery information, wherein the non-cash cash-on-delivery information corresponds to the identifying docket number; the third apparatus for recording the payment amount of a deal and the identifying docket number; the fourth apparatus, connected to a wireless networking and a financial network; the fifth apparatus receiving a paying medium information and the identifying docket number through a wireless communication protocol by the wireless network; the sixth apparatus for identifying the identifying docket number and the payment amount for the deal to generate a identifying result; the seventh apparatus for providing paying medium information and the payment amount of the deal through the financial network by the identifying result; the eighth apparatus for receiving an authorization, wherein the financial institution provides the authorization through the financial network according to the paying medium information and the payment amount of the deal; and the ninth apparatus for converting the authorization to an authorization information and providing the authorization information through the wireless communication protocol by the wireless network.

Besides, the wireless transportation apparatus, connected to the wireless network, comprises: the tenth apparatus for reading the identifying docket number by the first carrier; the eleventh apparatus for reading a paying medium information of a non-cash paying medium; the twelfth apparatus for transporting the paying medium information and identifying docket number to the logistics sub-system through the wireless communication protocol by the wireless network; the thirteenth apparatus for receiving the authorization information through the wireless communication protocol by the wireless network; and the fourteenth apparatus for printing the authorization information in the second carrier.

The foregoing description is not intended to be exhaustive or to limit the invention to the precise forms disclosed. Obvious modifications or variations are possible in light of the above teachings. In this regard, the embodiment or embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the inventions as determined by the appended claims when interpreted in accordance with the breath to which they are fairly and legally entitled.

It is understood that several modifications, changes, and substitutions are intended in the foregoing disclosure and in some instances some features of the invention will be employed without a corresponding use of other features. Accordingly, it is appropriate that the appended claims be construed broadly and in a manner consistent with the scope of the invention.

1. A non-cash cash-on-delivery method, comprising:
a first party and a second party agreeing on a deal comprising a target item and a non-cash cash-on-delivery information, wherein the non-cash cash-on-delivery information comprises a payment amount;
the first party providing the non-cash cash-on-delivery information for a third party, and the first party acquiring a identifying docket number from the third party;
the third party recording the non-cash cash-on-delivery information and the identifying docket number in a server, wherein the non-cash cash-on-delivery information corresponds to the identifying docket number, and the server is connected to a wireless network and a financial network;
the first party indicating the identifying docket number on the target item by a first carrier and delivering the target item to the third party;
the identifying docket number is entered to a wireless transportation apparatus, wherein the wireless transportation apparatus is connected to the wireless network;
the second party providing a card swipe information for the wireless transportation apparatus by a credit card/financial card, wherein the wireless transportation apparatus comprises a first interface adopted for reading card swipe information of the credit card/financial card by the wireless transportation apparatus;
the wireless transportation apparatus transporting the card swipe information and the identifying docket number for the server through a wireless communication protocol by the wireless network;
the server identifying the identifying docket number with the payment amount to generate a identifying result, and providing the card swipe information and the payment amount for a financial institution through the financial network according to the identifying result;
the financial institution providing an authorization for the server through the financial network according to the card swipe information and the payment amount;
the financial institution transferring a first transfer amount to the third party according to the authorization;
the server converting the authorization to an authorization information, and providing the authorization information for the wireless transportation apparatus through the wireless communication protocol by the wireless network;
the wireless transportation apparatus printing the authorization information on a second carrier;
the second party providing a signature for the second carrier;
the third party providing the target item for the third party; and
the third party transferring a second transfer amount to the first party according to the authorization and the identifying docket number.

2. The method according to claim 1, wherein the wireless transportation apparatus reads the signature on the second carrier to generate signature information, and provides the signature information for the server through the wireless communication protocol by the wireless network.

3. The method according to claim 1, further comprising that the wireless transportation apparatus transports a password to the server through the wireless communication protocol by the wireless network, and the server provides the password for the financial institution through financial network, wherein the financial institution provides the authorization after identifying the card swipe information, the payment amount, and the password.

4. A non-cash cash-on-delivery method, comprising:
a first party and a second party agreeing on a deal comprising a target item and a non-cash cash-on-delivery information, wherein the non-cash cash-on-delivery information comprises a payment amount;
the first party providing the non-cash cash-on-delivery information for a third party, and the first party acquiring a identifying docket number from the third party;
the third party recording the non-cash cash-on-delivery information and the identifying docket number in a server, wherein the non-cash cash-on-delivery information corresponds to the identifying docket number, and the server is connected to a wireless network and a financial network;
the first party indicating the identifying docket number on the target item by a first carrier and delivering the target item to the third party, and the third party delivering the target item to the second party;
the identifying docket number is entered to a wireless transportation apparatus, wherein the wireless transportation apparatus is connected to the wireless network;
the second party providing a paying medium information for the wireless transportation apparatus by a non-cash paying medium, wherein the wireless transportation apparatus comprises a first interface adopted for reading card swipe information of the non-cash paying medium by the wireless transportation apparatus;
the wireless transportation apparatus transporting the card swipe information and the identifying docket number for the server through a wireless communication protocol by the wireless network;
the server identifying the identifying docket number with the payment amount to generate a identifying result, and providing the card swipe information and the payment amount for a financial institution through the financial network according to the identifying result;
the financial institution providing an authorization for the server through the financial network according to the card swipe information and the payment amount;
the financial institution transferring a first transfer amount to the third party according to the authorization;
the server converting the authorization to an authorization information, and providing the authorization information for the wireless transportation apparatus through the wireless communication protocol by the wireless network;
the wireless transportation apparatus printing the authorization information on a second carrier;
the second party providing a signature for the second carrier;
the third party providing the target item for the third party; and
the third party transferring a second transfer amount to the first party according to the authorization and the identifying docket number.

5. The method according to claim 4, wherein the wireless transportation apparatus comprises a second interface adopted for reading the identifying docket number from the first carrier.

6. The method according to claim 4, wherein the second party provides a signature on the second carrier.

7. The method according to claim 6, wherein the wireless transportation apparatus comprises a third interface adopted for reading the signature on the second carrier to generate a signature information, and the wireless transportation apparatus provides the signature information for the server through the wireless communication protocol by the wireless network.

8. The method according to claim 4, further comprising that the wireless transportation apparatus transports a password to the server through the wireless communication protocol by the wireless network, and the server provides the password for the financial institution through financial network, wherein the financial institution provides the authorization after identifying the card swipe information, the payment amount, and the password.

9. The method according to claim 4, wherein the non-cash paying medium comprises a credit card/financial card.

10. The method according to claim 4, wherein the non-cash paying medium comprises a mobile communication apparatus, and the mobile communication apparatus displays the multi-media information to provide the paying medium information, and the multi-media information is selected from a combination of a group consisting of image, voice, and text.

11. The method according to claim 4, wherein the mobile communication apparatus comprises an image scanning apparatus adopted for reading the identifying docket number from the first carrier.

12. The method according to claim 4, wherein the identifying docket number is indicated on the first carrier in a one-dimension bar code/two-dimension bar code format.

13. A non-cash cash-on-delivery system, comprising:
a logistics sub-system comprises at least a computer system with a logistics managing software so that the logistics sub-system comprises the following apparatuses:
a first apparatus for receiving non-cash cash-on-delivery information, wherein the first party and the second party agree on a deal comprising a target item and the non-cash cash-on-delivery information, wherein the non-cash cash-on-delivery information comprises a payment amount;
a second apparatus for generating a identifying docket number according to the non-cash cash-on-delivery information, wherein the non-cash cash-on-delivery information corresponds to the identifying docket number;
a third apparatus for recording the payment amount of a deal and the identifying docket number;
a fourth apparatus, connected to a wireless networking and a financial network;
a fifth apparatus receiving a paying medium information and the identifying docket number through a wireless communication protocol by the wireless network;
a sixth apparatus for identifying the identifying docket number and the payment amount for the deal to generate a identifying result;
a seventh apparatus for providing paying medium information and the payment amount of the deal through the financial network by the identifying result;
a eighth apparatus for receiving an authorization, wherein the financial institution provides the authorization through the financial network according to the paying medium information and the payment amount of the deal; and
a ninth apparatus for converting the authorization to an authorization information and providing the authorization information through the wireless communication protocol by the wireless network.
at least a wireless transportation apparatus, connected to the wireless network, comprising:
a tenth apparatus for reading the identifying docket number by the first carrier;
a eleventh apparatus for reading a paying medium information of a non-cash paying medium;
a twelfth apparatus for transporting the paying medium information and identifying docket number to the logistics sub-system through the wireless communication protocol by the wireless network;
a thirteenth apparatus for receiving the authorization information through the wireless communication protocol by the wireless network; and
a fourteenth apparatus for printing the authorization information in the second carrier.

14. The system according to claim 13, wherein the wireless transportation apparatus further comprises an apparatus for reading a signature on the second carrier to generate signature information, wherein the second party provides the signature for the second carrier.

15. The system according to claim 14, wherein the wireless transportation apparatus provides the signature information for the logistics sub-system through the wireless communication protocol by the wireless network.

16. The system according to claim 14, wherein the wireless transportation apparatus transports a password to the server through the wireless communication protocol by the wireless network, and the server provides the password for the logistics sub-system through financial network, wherein the logistics sub-system provides the authorization after identifying the paying medium information, the payment amount, and the password.

17. The system according to claim 14, wherein the non-cash paying medium comprises a credit card/financial card.

18. The system according to claim 14, wherein the non-cash paying medium comprises a mobile communication apparatus, and the mobile communication apparatus displays the multi-media information to provide the paying medium information, and the multi-media information is selected from a combination of a group consisting of image, voice, and text.

19. The system according to claim 14, wherein the mobile communication apparatus comprises an image scanning apparatus adopted for reading the identifying docket number from the first carrier.

20. The system according to claim 14, wherein the identifying docket number is indicated on the first carrier in a one-dimension bar code/two-dimension bar code format.
